(19) United States
(12) Patent Application Publication
(10) Pub. No.: US 2015/0101987 A1
(43) Pub. Date: Apr. 16, 2015

(54) STACKED PLATE-SHAPED COMPOSITE MEMBRANE CARTRIDGE

(71) Applicant: Synder Filtration, Vacaville, CA (US)

(72) Inventors: Edward Yeh, Fairfield, CA (US); Joseph Wang, Fairfield, CA (US); Yongming Zhang, Taizhou City (CN)

(21) Appl. No.: 14/510,968

(22) Filed: Oct. 9, 2014

Related U.S. Application Data
(60) Provisional application No. 61/912,954, filed on Dec. 6, 2013.

(30) Foreign Application Priority Data
Oct. 12, 2013 (CN) 201310474880.1
Oct. 12, 2013 (CN) 201320628884.6
Oct. 14, 2013 (CN) 201320628699.7
Oct. 14, 2013 (CN) 201320628798.5

(51) Int. Cl. B01D 69/12; C02F 1/44; B01D 39/04; C02F 1/00; B01D 29/56; B01D 36/02

(52) U.S. Cl. CPC B01D 69/12; B01D 29/56; B01D 36/02; B01D 39/04; C02F 1/001; C02F 1/442
USPC 210/650; 210/335; 210/321.6; 210/321.83; 210/287

(57) ABSTRACT

A composite filter membrane cartridge, including a housing with a raw water inlet and a filtered water outlet is disclosed. The housing may be equipped with one or more filter layers, including a prefilter assembly and a second filter portion, wherein the prefilter is connected to the membrane filer either via a water line or by direct stacking. The prefilter assembly may include multiple layers comprising a carbon filter and polypropylene cotton filter, wherein the locations of the filters are interchangeable. The prefilter may include granular activated carbon situated between two portions of polypropylene cotton filter cloth. The perimeter of the activated carbon filter and polypropylene cotton filter may be substantially sealed around the inner wall of the housing providing a snug fit. The second filter portion of the composite filter membrane cartridge may include nanomembrane spiral wound filter.

### CROSS-REFERENCE TO RELATED APPLICATIONS

The present invention and application relates to, and claims the benefit of the earlier filing date and priority of U.S. patent application Ser. No. 61/912,954, filed on Dec. 6, 2013, Chinese Patent Application No. 201320628798.5 filed on Oct. 14, 2013, Chinese Patent Application No. 201320628699.7 filed on Oct. 14, 2013, Chinese Patent Application No. 201310474880.1 filed on Oct. 12, 2013 and Chinese Patent Application No. 201320628884.6 filed on Oct. 12, 2013.

### FIELD OF THE INVENTION

The present invention relates to the apparatus and systems for the purification of liquids using a stacked plate-shaped composite membrane cartridge.

### BACKGROUND OF THE INVENTION

As living standards continue to improve and drinking water health awareness continues to increase, more and more people are drinking purified water.

Traditional water purification filters are generally composed of several cartridges and laid out as multi-stage filters. The cartridges can hold different types of filters, depending on the different requirements of purification and various quality of the raw water. With multiple cartridges, the water purification system typically requires a large footprint as well as consumes a great amount of raw materials. Moreover, the traditional pre-filter such as polypropylene (“PP”) cotton filter is made into a cylindrical shape, with an open channel in the center. It is an inefficient use of space thus making transportation and installation of the filter inconvenient. In addition, if the filters don't snuggly fit in the cartridge, which is very common in known filtration systems, it will result in a leakage of raw water through the gap between the filter and the housing, and as a result, the desired level of filtration and the effectiveness of the filtration is diminished. The purposes of the present invention are to overcome the shortcomings of the previously known systems discussed above.

### SUMMARY OF THE INVENTION

An embodiment of the present invention is a composite membrane cartridge comprising a housing having a fluid inlet and a fluid outlet and a prefilter comprising at least one carbon filter and at least one polypropylene cotton filter wherein the elements of the composite membrane cartridge are arranged such that fluid flows from the fluid inlet through at least a portion of the carbon filter and at least a portion of the polypropylene cotton filter and exits the housing through the fluid outlet. The composite membrane cartridge may further comprise nanofiltration membrane filter, wherein the nanofiltration membrane filter may be spiral wound.

In an embodiment the carbon filter and the polypropylene cotton filter may have a perimeter that is substantially affixed to an interior surface of the housing. In an embodiment the at least one carbon filter may comprise carbon granules. In various embodiments the at least one polypropylene cotton filter may comprise a cotton filter cloth. In an embodiment the composite membrane cartridge housing may be cylindrical.

In an embodiment the prefilter and/or the carbon filter and/or the polypropylene cotton filter may be plate-shaped. In an embodiment the carbon filter may be disposed between at least two polypropylene cotton filters. In an embodiment the carbon granules may be disposed between two portions of cotton filter cloth. In an embodiment the prefilter and nanofiltration membrane filter may be vertically stacked.

In an embodiment the prefilter may be connected to the nanofiltration membrane filter via a water line. In an embodiment the housing comprises a component comprising the prefilter and a component comprising the nanofiltration membrane. In an embodiment the component comprising the prefilter is attached to the component comprising the nanofiltration membrane via a water line. In an embodiment at least one of the carbon filter and at least one of the polypropylene cotton filter may be replaceable.

In an embodiment the housing may be in the range of about 10 millimeters to about 500 millimeters, or in the range of about 50 millimeters to about 250 millimeters in diameter. In an embodiment the carbon granules may be in the range of about 10 mesh to about 100 mesh, or about 20 mesh to about 50 mesh. In an embodiment the polypropylene cotton filter may comprise pores ranging from about 0.1 microns to about 10 microns, or from about 1 micron to about 5 microns in diameter. In an embodiment the diameter of at least one of the housing, the carbon filter and the polypropylene cotton filter may be in the range of about 10 millimeters to about 500 millimeters, or about 50 millimeters to about 250 millimeters. In an embodiment the nanofiltration membrane filter may comprise pores ranging from about 150 Da to about 1000 Da in diameter. In an embodiment a housing liner may be disposed within the housing, and the carbon filter and the polypropylene cotton filter have a perimeter that is affixed to an interior surface of the housing liner.

An embodiment of the present invention is a composite membrane cartridge comprising a housing having a fluid inlet and a fluid outlet and a prefilter comprising at least one carbon filter and at least one polypropylene cotton filter wherein the elements of the composite membrane cartridge are arranged such that fluid flows from the fluid inlet through at least a portion of the carbon filter and at least a portion of the polypropylene cotton filter and exits the housing through the fluid outlet and wherein the carbon filter and the polypropylene cotton filter have a perimeter that is substantially affixed to an interior surface of the housing.

An embodiment of the present invention is a method for filtering a liquid comprising introducing the liquid to be filtered into a composite membrane cartridge comprising a housing having a fluid inlet and a fluid outlet and a prefilter comprising at least one carbon filter and at least one polypropylene cotton filter such that fluid flows from a fluid inlet through at least a portion of the carbon filter and at least a portion of the polypropylene cotton filter and exits the housing through a fluid outlet.

### BRIEF DESCRIPTION OF THE DRAWINGS

FIG. 1 is a cross-sectional schematic diagram of one embodiment of the present invention.

FIG. 2 is a cross-sectional schematic diagram of one embodiment of the present invention in which a prefilter is connected to a membrane filter via a water line.

### DETAILED DESCRIPTION

An embodiment of the present invention comprises a composite membrane cartridge comprising at least one filter, at least one of which comprises a housing having a raw fluid inlet and a filtered fluid outlet, a prefilter comprising at least one carbon filter and at least one polypropylene cotton filter, wherein fluid flows from the raw fluid inlet in the housing through at least a portion of the carbon filter and at least a portion of the polypropylene cotton filter and exits the housing through the filtered fluid outlet. In an embodiment of the present invention, the composite membrane cartridge may further comprise a nanofiltration membrane filter.

In an embodiment of the present invention, a composite membrane cartridge comprises at least two filters or portions, one of which serves as a prefilter and another of which contains or serves as a nanofiltration membrane filter. In an embodiment of the present invention, the output of the prefilter may be connected or otherwise feed into an inlet of the nanofiltration membrane filter. This connection may be established, by way of example, by a water line, by stacking the prefilter to the nanofiltration membrane filter inside the same housing, or by a variety of like configurations that would be appreciated by one of ordinary skill in the art after reading the present disclosure.

The carbon filter and the polypropylene cotton filter may have a perimeter or circumference wherein the perimeter is fixedly sealed to an interior surface of the housing or in some embodiments, a housing liner. In an embodiment, the composite membrane cartridge housing may be cylindrical in shape. The composite membrane may be spiral wound in an embodiment of the present invention. In an embodiment, the prefilter comprises a plate-shaped cotton filter cloth and carbon granules may be disposed between two portions of the cotton filter cloth. In an embodiment the carbon filter and the polypropylene cotton filter may be cylindrical. In an embodiment the composite membrane cartridge housing may be circular plate-shaped. In an embodiment the composite membrane cartridge carbon filter and polypropylene cotton filter may be circular plate-shaped.

In an embodiment, the carbon and polypropylene cotton filters are vertically stacked. In an embodiment, a carbon filter may be disposed between at least two polypropylene cotton filters. In an embodiment the composite membrane cartridge may comprise at least two carbon filters and at least two polypropylene cotton filters.

In an embodiment, at least one of the carbon filter and at least one of the polypropylene cotton filter is replaceable. In an embodiment, at least one of the carbon filter and at least one of the polypropylene cotton filter are interchangeable. In an embodiment, the carbon filter comprises activated granules in a cylindrical shape. In an embodiment, the polypropylene cotton filter may be in the range of about 1 to about 5 microns thick along its transverse axis and one of the housing, the carbon filter, and the polypropylene cotton filter diameter may be in the range of about 80 millimeters to about 100 millimeters or more. One of ordinary skill in the art will appreciate that the present invention may be implemented using thicker polypropylene layers to prevent a greater quantity of larger particles from passing through the filter. As an increase in polypropylene layer thickness may lead to lower flux, the present invention may be implemented by seeking a balance between layer thickness and flux.

In an embodiment, a prefilter may comprise a desirable concentration of carbon. By way of example and without limiting the present invention, in one embodiment a carbon filter comprises about 500 grams of carbon and may be in the range of about 80 to 100 millimeters in diameter. One of ordinary skill in the art will appreciate the present invention may be practiced using a filter characterized by a greater or lesser range, or more or fewer grams of carbon.

Transverse in this application is defined as vertical, relating to the thickness or height of an object as opposed to longitudinal defined as horizontal, length, width, or diameter of an object. Measurements provided are not meant to be limiting, and are determined by application. The measurements are for an example embodiment only, and those of ordinary skill in the art would realize that the invention according to embodiments of the present disclosure would be limited in size solely based on the particular application required.

An embodiment of the present invention provides a stacked plate-shaped composite membrane filter with high efficiency, having a smaller footprint, and is more economical in manufacture and use than other known systems. An embodiment of the present invention seeks to maximize the water volume output rate of the filter, which may be measured as a function of the type of membrane used and the overall surface area of the filter. The stacked plate-shaped composite membrane cartridge according to an embodiment of the present invention comprises a housing with one raw water inlet and one filtered water outlet. Raw water, as used herein, may include but is not limited to municipal tap water, well water, ground water, rain water, water from lakes and streams, or water from other sources external to the cartridge in use.

The use of the term water in this application is by way of example only and by no means limits embodiments of the present invention solely to the filtration of water. Other liquids and/or fluids, including, but not limited to, such as alcohol, alcohol-water mixtures, urine, or organic liquids, including, but not limited to, edible or motor oils and the like may be used with embodiments of the present invention.

When the raw water is introduced into the cartridge through the raw fluid inlet, the water proceeds through steps of pre-filtration and the final filtration with a nanofiltration membrane and then exiting through the filtered water outlet. The pre-filtration is realized by filtering the water with at least one layer of PP cotton filter paper and carbon filter where the locations of the filters are interchangeable. In one embodiment, the pore size of the filter ranges from about 150 Da to about 1000 Da or is otherwise determined by molecular weight cut-off. The PP cotton filter paper is in flat form and the edge of the filter paper is tightly sealed inside the housing and/or housing liner and the activated carbon media may be filled between at least two layers of PP cotton filter paper.

In an embodiment the stacked plate-shaped filter paper and the activated carbon media are sealed snuggly around the inner wall of the housing, or a housing liner, by a sealant. In an embodiment, the amount of carbon media and the quantity and total thickness of the PP cotton filter papers depend on the quality of the raw water entering the filter. In an embodiment the paper filters that are used in the cartridge can be made with varying pore sizes and varying materials, such as, but not limited to, polyester, polypropylene, nylon, stainless steel, etc. depending on the raw water quality. In an embodiment the final filtration may be achieved by a nanofiltration membrane. The nanofiltration membrane may retain small molecules between about 150 and about 800 molecular weight cutoff, including part of the monovalent salt, and the majority of divalent and polyvalent salts. Nanofiltration produces high quality water, so it has a high and broad application potential for the food industry, the pharmaceutical industry, the chemical industry, and the drinking water industry. Currently in the field of water purification nanofiltration membranes have gradually replaced the traditional reverse osmosis (“RO”) membrane.

The composite membrane filters according to an embodiment of the present invention are disposed within a housing and/or housing liner having a raw water inlet and a filtered water outlet, the housing having a fine filtration element, such as, but not limited to, a nanofilter or the like, and prior to the fine filtration element there may be a pre-filter assembly with at least one layer comprising each of a carbon filter and PP cotton filter. The PP cotton filter is a flat filter, the activated carbon filter and PP cotton filter are snuggly sealed around the inner wall of the housing or housing liner. The raw water may be pre-filtered and then filtered through a nanofiltration filter, which will substantially remove harmful material from the water and allow desirable minerals that are good for human health to pass through.

In one embodiment of the present invention, the activated carbon filter and PP cotton filter are snuggly sealed around the inner wall of the housing and/or housing liner, substantially sealing the edge of the filters to the inner wall of the housing and/or liner. The amount of carbon and the quantity and thickness of the PP cotton stacked together can vary depending on the raw water quality feeding into the filter cartridge and the desired purity of the water exiting the filter cartridge.

With the use of the above technology, embodiments of the present invention have at least several advantages over existing technology. For example, the integrated cartridge covers the filter elements, including, but not limited to, carbon filter and PP cotton filter, in a single housing. The installation will take less space, save manufacturing cost, and make it more convenient to use than currently known systems. Utilizing plate-like filter elements, instead of the original cylindrical structures, embodiments of the present invention will save space, enhance filtration area, and improve filtration effect, and also allows the filter cartridge to be adjustable in terms of filter area according to the raw water quality. The final filter element of certain embodiments of the present invention may be a nanofiltration (“NF”) membrane, which has a larger pore size than regular reverse osmosis (“RO”) membranes. Therefore, after nanofiltration, the harmful impurities such as bacteria are substantially removed, while retaining the minerals needed by the body. Further, the activated carbon filter and PP cotton filter of an embodiment of the present invention are substantially sealed with the inner wall of the housing and/or housing liner through a sealant, the sealant being applied on the circumference of the filter and/or around the surface of the inner wall of the housing and/or housing liner where the edge of the filters contact the inner wall, to ensure that raw water is substantially prevented from seeping through the gap between the inner wall and the edge of the filter elements, thus improving the quality of the drinking water.

### EXAMPLE 1

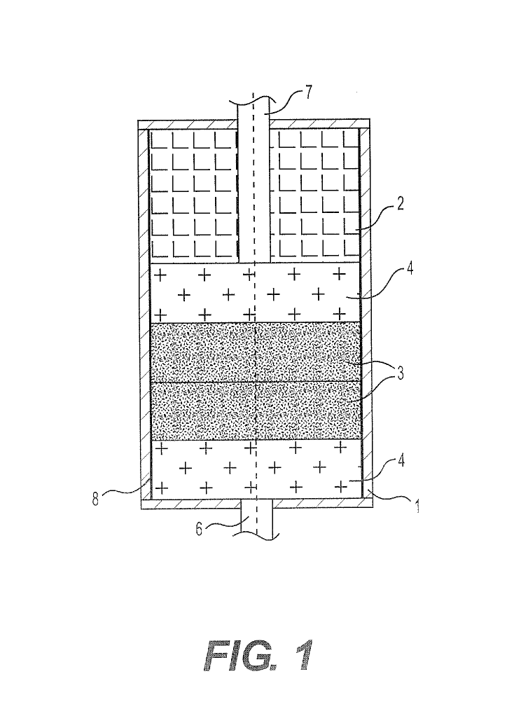

FIG. 1 depicts an embodiment of the present invention, comprising at least the following elements: housing 1; nanofiltration membrane filter 2; activated carbon filter 3; PP cotton filter 4; sealant 8; raw water inlet 6 and filtered water outlet 7.

Referring to FIG. 1, an embodiment of the present invention comprises a cylindrical composite membrane filter stack cartridge device, comprising raw water inlet 6 and filtered water outlet 7 disposed in housing 1. Inside housing 1 there is at least one fine filter. In one embodiment, the fine filter may be nanofiltration filter 2. Also disposed in housing 1 are at least one filter layer comprising an activated carbon filter 3 and at least one filter layer comprising a PP cotton filter 4 that are stacked and can be interchanged vertically. Activated carbon filter 3 and PP cotton filter 4 are plate-shaped filters. Filters 3 and 4 may also be square or rectangular tray-shaped or the like. Activated carbon filter 3 and PP cotton filter 4 are substantially sealed to the inner wall of housing 1 through sealant 8 providing a substantially snug fit and/or a substantially tight seal. Sealant 8 may be comprised of silicone or any other suitable material, such as, but not limited to polyurethane or epoxy glues. In one embodiment, activated carbon filter 3 and PP cotton filter 4 may be substantially sealed to a housing liner (not shown) that is disposed within the inner wall of housing 1. The filtering capacity of carbon filter 3 and PP cotton filter 4 can be increased or decreased by varying the number of individual filters and/or thickness of the individual filter, as needed based on the quantity and quality of the raw water and desired flow rate and purity of the filtered water.

In an embodiment, housing 1 is internally provided with two layers of carbon filter 3 and two layers of PP cotton filter 4. In an embodiment, the two layers of PP cotton filters 4 sandwich the two layers of activated carbon filter 3. If the raw water quality is poor, the filtering effect can be improved by adding additional layers of carbon filter 3 and/or PP cotton filter 4. Conversely, if the raw water quality is better, one may reduce the layers of carbon filter 3 and PP cotton filter 4 to reduce the cost and the filter's physical footprint. In addition, using PP cotton filter 4 in a round plate-shape, instead of the known cylindrical structure, removes the empty space from the central tubular flow channel. This embodiment not only saves space, but also increases the filtration area, improves the filtering effect, and reduces the amount of water that may seep around the filters. The device is flexible and user-friendly since the number of filters is adjustable based upon the raw water quality. Moreover, the perimeter edge of activated carbon filter 3 and PP cotton filter 4 of an embodiment of the present invention are substantially sealed to the inner wall of housing 1 or housing liner through the use of sealant 8. Sealant 8 ensures that the raw water will not substantially bypass the filter, so filtration effectiveness is improved over known systems.

### EXAMPLE 2

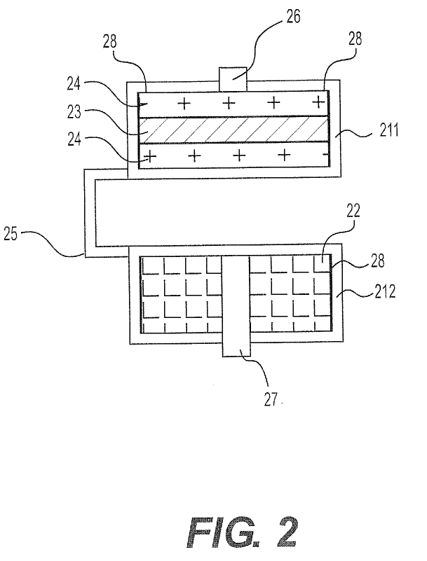

FIG. 2 depicts an embodiment of the present invention, comprising at least the following elements: first housing component 211; second housing component 212; nanofiltration membrane filter 22; activated carbon filter 23; PP cotton filter 24; water line 25; raw water inlet 26; filtered water outlet 27; and sealant 28.

Referring to FIG. 2, an embodiment of the present invention comprises a cylindrical composite membrane filter stack cartridge device, comprising first housing component 211 and second housing component 212, connected via water line 25. Water to be filtered is introduced to raw water inlet 26 and exits the filter via filtered water outlet 27. Inside first housing component 212 are at least one filter layer comprising an activated carbon filter 23 and at least one filter layer comprising a PP cotton filter 24 that are stacked and can be interchanged vertically. Inside second housing component 212, there is at least one fine filter. In one embodiment, the fine filter may be nanofiltration filter 22. Activated carbon filter 23 and PP cotton filter 24 may be plate-shaped filters. Filters 23 and 24 may also be square, rectangular tray-shaped, or the like. Activated carbon filter 23 and PP cotton filter 24 are substantially sealed to the inner wall of housing 211 or a housing liner through sealant 28 providing a substantially snug fit. Sealant 28 may be comprised of silicone or any other suitable material, such as, but not limited to polyurethane or epoxy glues. The filtering capacity of carbon filter 23 and PP cotton filter 24 can be increased or decreased by varying the number of individual filters and/or thickness of the individual filter, as needed based on the quantity and quality of the raw water and desired flow rate and purity of the filtered water.

In an embodiment, first housing component 211 is internally provided with two layers of carbon filter 23 and two layers of PP cotton filter 24. In an embodiment, the two layers of PP cotton filters 24 sandwich the two layers of activated carbon filter 23. If the raw water quality is poor, the filtering effect can be improved by adding additional layers of carbon filter 23 and/or PP cotton filter 24. Conversely, if the raw water quality is better, one may reduce the layers of carbon filter 23 and PP cotton filter 24 to reduce the cost and the filter's physical footprint. In addition, using PP cotton filter 24 in a round plate-shape, instead of the known cylindrical structure, removes the empty space from the central tubular flow channel.

This embodiment not only saves space, but also increases the filtration area, improves the filtering effect, and reduces the amount of water that may seep around the filters. The device is flexible and user-friendly since the number of filters is adjustable based upon the raw water quality. Moreover, the perimeter edge of activated carbon filter 23 and PP cotton filter 24 of an embodiment of the present invention are substantially sealed to the inner wall of housing 1 or a housing liner through the use of sealant 28. Sealant 28 ensures that the raw water will not substantially bypass the filter, so filtration effectiveness is improved over known systems.

In one embodiment, the stacked cylindrical composite membrane cartridge comprises a housing with at least one raw water inlet and at least one filtered water outlet. When the raw water is introduced into the cartridge, the water goes through steps of prefiltration and the final filtration with nanofiltration membrane and then leaving through the filtered water outlet. In one embodiment, prefiltration involves filtering the water with layers of PP cotton filter papers and carbon filter where the locations of the filters are exchangeable. The PP cotton filter paper is in flat form and the edge of the filter paper is substantially tight-sealed inside the housing or housing liner and the activated carbon media is filled between two layers of PP cotton filter paper.

In one embodiment, the stacked plate-shaped filter paper and the activated carbon media are sealed snuggly around the inner wall of the housing or housing liner by sealant.

In one embodiment, the amount of carbon media and the quantity and total thickness of the PP cotton filter papers depend on the water quality of the raw water entering the filter.

In one embodiment, a cotton filter cloth or polypropylene cotton filter that is used in the cartridge can be made with different pore sizes ranging from about 0.01 microns to about 10 microns, preferably between about 1 micron and about 5 microns, and different material depending on the quality of the raw water to be filtered. The prefilter materials in this embodiment may be, but are not limited to, one or more of polyester, polypropylene, nylon, or even stainless steel.

In one embodiment, the final filtration is achieved by a nanofiltration membrane. Nanofiltration membrane can retain small molecules between about 150 Da to about 1000 Da or molecular weight cut-off, including part of the monovalent salt, majority of divalent and polyvalent salts.

Nanofiltration produces high quality water, so it has a high and broad application potential for food industry, pharmaceutical industry, chemical industry, and drinking water industry. In 2004, reports from the World Health Organization indicated that completely demineralized water, such as RO water, may be corrosive. Nanomembrane filtered water may contain between 70-80% divalent salts. Compared to water filtration through reverse osmosis, ultrafiltration, and microfiltration techniques, nanaofiltered water is considered to be the healthiest drinking water. Currently in the field of water purification, nanofiltration membranes have gradually replaced the traditional reverse osmosis membrane, due in part to the corrosive qualities of water filtered through reverse osmosis.

The embodiments above are provided to illustrate the utility of embodiments of the present invention, and its purpose is to allow a person to become familiar with the technology with an understanding of the content of the technology and thus being able to implement it. It's not intended to limit the scope of protection of the utility model. Wherever there are changes or modifications made to the equivalent of the new practical model, it should be covered in the utility model protection range.

1. A composite membrane cartridge comprising:
a housing having a fluid inlet and a fluid outlet; and
a prefilter comprising at least one carbon filter and at least one polypropylene cotton filter;
wherein the elements of the composite membrane cartridge are arranged such that fluid flows from the fluid inlet through at least a portion of the carbon filter and at least a portion of the polypropylene cotton filter and exits the housing through the fluid outlet.

2. The composite membrane cartridge according to claim 1, further comprising a nanofiltration membrane filter.

3. The composite membrane cartridge according to claim 2, wherein the nanofiltration membrane filter is spiral wound.

4. The composite membrane cartridge according to claim 1, wherein the carbon filter and the polypropylene cotton filter have a perimeter that is substantially affixed to an interior surface of the housing.

5. The composite membrane cartridge according to claim 1, wherein the at least one carbon filter comprises carbon granules.

6. The composite membrane cartridge according to claim 1, wherein the at least one polypropylene cotton filter comprises a cotton filter cloth.

7. The composite membrane cartridge according to claim 1, wherein the housing is cylindrical.

8. The composite membrane cartridge according to claim 1, wherein the prefilter is plate-shaped.

9. The composite membrane cartridge according to claim 1, wherein at least one of the carbon filter and the polypropylene cotton filter is plate-shaped.

10. The composite membrane cartridge according to claim 1, wherein the carbon filter is disposed between at least two polypropylene cotton filters.

11. The composite membrane cartridge according to claim 5, wherein the carbon granules are disposed between two portions of cotton filter cloth.

12. The composite membrane cartridge according to claim 2, wherein the prefilter and nanofiltration membrane filter are vertically stacked.

13. The composite membrane cartridge according to claim 2, wherein the prefilter is connected to the nanofiltration membrane filter via a water line.

14. The composite membrane cartridge according to claim 2, wherein the housing comprises a component comprising the prefilter and a component comprising the nanofiltration membrane.

15. The composite membrane cartridge according to claim 14, wherein the component comprising the prefilter is attached to the component comprising the nanofiltration membrane via a water line.

16. The composite membrane cartridge according to claim 1, wherein at least one of the carbon filter and at least one of the polypropylene cotton filter is replaceable.

17. The composite membrane cartridge according to claim 1, wherein the housing is in the range of about 10 millimeters to about 500 millimeters in diameter.

18. The composite membrane cartridge according to claim 1, wherein the housing is in the range of about 50 millimeters to about 250 millimeters in diameter.

19. The composite membrane cartridge according to claim 5, wherein the carbon granules are in the range of about 10 mesh to about 100 mesh.

20. The composite membrane cartridge according to claim 5, wherein the carbon granules are in the range of about 20 mesh to about 50 mesh.

21. The composite membrane cartridge according to claim 1, wherein the polypropylene cotton filter comprises pores ranging from about 0.1 microns to about 10 microns in diameter.

22. The composite membrane cartridge according to claim 1, wherein the polypropylene cotton filter comprises pores ranging from about 1 micron to about 5 microns in diameter.

23. The composite membrane cartridge according to claim 1, wherein the diameter of at least one of the housing, the carbon filter and the polypropylene cotton filter is in the range of about 10 millimeters to about 500 millimeters.

24. The composite membrane cartridge according to claim 1, wherein the diameter of at least one of the housing, the carbon filter and the polypropylene cotton filter is in the range of about 50 millimeters to about 250 millimeters.

25. The composite membrane cartridge according to claim 2, wherein the nanofiltration membrane filter comprises pores ranging from about 150 Da to about 1000 Da in diameter.

26. The composite membrane cartridge according to claim 1, wherein a housing liner is disposed within the housing, and the carbon filter and the polypropylene cotton filter have a perimeter that is affixed to an interior surface of the housing liner.

27. A composite membrane cartridge comprising:
a housing having a fluid inlet and a fluid outlet; and
a prefilter comprising at least one carbon filter and at least one polypropylene cotton filter;
wherein the elements of the composite membrane cartridge are arranged such that fluid flows from the fluid inlet through at least a portion of the carbon filter and at least a portion of the polypropylene cotton filter and exits the housing through the fluid outlet; and
wherein the carbon filter and the polypropylene cotton filter have a perimeter that is substantially affixed to an interior surface of the housing.

28. A method for filtering a liquid comprising:
introducing the liquid to be filtered into a composite membrane cartridge comprising a housing having a fluid inlet and a fluid outlet and a prefilter comprising at least one carbon filter and at least one polypropylene cotton filter such that fluid flows from a fluid inlet through at least a portion of the carbon filter and at least a portion of the polypropylene cotton filter and exits the housing through a fluid outlet.
